(19) United States
(12) Patent Application Publication
(10) Pub. No.: US 2010/0328247 A1
(43) Pub. Date: Dec. 30, 2010

(54) TOUCH PANEL SENSOR

(75) Inventors: Aya Miki, Hyogo (JP); Hiroshi Goto, Hyogo (JP); Hiroyuki Okuno, Hyogo (JP); Tomoya Kishi, Hyogo (JP); Akira Nanbu, Hyogo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA KOBE SEIKO SHO (KOBE STEEL, LTD.), Kobe-shi, Hyogo (JP)

(21) Appl. No.: 12/918,727

(22) PCT Filed: Feb. 20, 2009
(86) PCT No.: PCT/JP2009/053094

§ 371 Date: Aug. 20, 2010

(30) Foreign Application Priority Data
Feb. 22, 2008 (JP) 2008-041662

(51) Int. Cl. G06F 3/041

(52) U.S. Cl. 345/173

(57) ABSTRACT

Disclosed is a highly reliable touch panel sensor comprising a guiding wiring that is less likely to cause an increase in electrical resistance and disconnection with the elapse of time, has a low electrical resistance, can ensure electrical conduction to a transparent conductive film, and can be connected directly to the transparent conductive film. The touch panel sensor comprises a transparent conductive film and a guiding wiring made of an aluminum alloy film connected directly to the transparent conductive film. The aluminum alloy film comprises 0.2 to 10 atomic% in total of at least one element selected from an X group consisting of Ni and Co. The aluminum alloy film has a hardness of 2 to 15 GPa.

### TECHNICAL FIELD

The present invention relates to touch panel sensors, and more particularly, to a touch panel sensor including a transparent conductive film, and a guiding wiring directly contacted to the transparent conductive film and made of an aluminum alloy film.

### BACKGROUND ART

Touch panel sensors disposed on the front side of an image display device and used as an input switch integral with the image display device are easy to use, and thus have been widely used in operation screens of, for example, an automated teller machine of a bank, a ticket-vending machine, a car navigation system, a PDA, a copy machine, and the like. Detection mechanisms of an input point include a resistance film type, a capacitance type, an optical type, an ultrasonic surface elastic wave type, a piezoelectric type, and the like. Among them, the resistance film type detection mechanism is most widely used because of low cost, simple structure, and the like.

The resistance film type touch panel sensor mainly includes an upper electrode, a lower electrode, and a tail. A transparent conductive film provided on a substrate (for example, a film substrate) included in the upper electrode, and a transparent conductive film provided on another substrate (for example, a glass substrate) included in the lower electrode are opposed to each other via a spacer. When a finger, a pen, or the like touches the film side of such a touch panel sensor, both transparent conductive films are brought into contact with each other, so that current flows through the electrodes on both ends of the transparent conductive films. And, a voltage division ratio due to resistances of the respective transparent conductive films is measured thereby to detect the touched position.

In a process for manufacturing the touch panel sensor, a guiding wiring for coupling the transparent conductive film to a control circuit is generally formed by printing a conductive paste, such as a silver paste, or a conductive ink by ink-jet technology or other printing methods. The wiring made of pure silver or silver alloy, however, has bad adhesion to glass, resin, or the like. Further, the wiring material is flocculated on the substrate at a contacting part to an external device, which leads to an increase in electrical resistance or failures, such as disconnection.

As one of techniques for improving the reliability of the guiding wiring made of silver paste, Patent Document 1 discloses a method for forming a part of the wiring by use of plating or a metal foil. The method, however, still uses the silver paste in a contacting part between the external device and the wiring formed by plating or of the metal foil, which makes it difficult to further enhance the strength of the contacting part between the wiring and the external device.

The touch panel sensor is a sensor for sensing the presence of touch of a finger of a person or the like. The touch panel sensor is temporarily deformed slightly due to a stress applied by the touch. The repeated use of the touch panel repeatedly causes the slight deformation, so that the stress is also repeatedly applied to the guiding wiring. Thus, the wiring is required to have adequate durability (resistance to stress). The guiding wiring formed using the conductive paste made of pure silver or silver alloy does not have enough durability. The guiding wiring may be easily damaged during using the touch panel. The damage to the guiding wiring increases the electrical resistance of the wiring to induce a voltage drop, which tends to reduce the accuracy of detecting the position by the touch panel sensor. In employing a pen touch type touch panel, it is necessary to narrow a pitch between the wirings. However, the formation of the wiring using the paste is performed by a coating technique, which makes it difficult to narrow the pitch.

Patent Document 2 discloses a mixture of silver powder, an organic resin, and a solvent as a conductive paste with excellent durability. The guiding wiring obtained by using the conductive paste comprised of the silver powder, the organic resin, and the solvent has an electrical resistivity of about 1×10⁻¹ Ω·cm (which is about thirty times as large as the electrical resistivity of aluminum bulk), and thus is not defined as one with a sufficient low electrical resistance.

On the other hand, it is also proposed that pure aluminum having a sufficient low electrical resistivity is applied as material of the guiding wiring. The use of pure aluminum as material for the guiding wiring, however, forms insulating aluminum oxide between the pure aluminum film and the transparent conductive film in the touch panel sensor, which cannot ensure the electrical conductivity.
[Patent Document 1] Japanese Unexamined Patent Publication No. 2007-18226
[Patent Document 2] Japanese Unexamined Patent Publication No. 2006-59720

### DISCLOSURE OF THE INVENTION

### Problem to be Solved by the Invention

The present invention has been made in view of the forgoing circumstances, and it is an object of the present invention to provide a touch panel sensor with high reliability, including a guiding wiring which is less likely to cause disconnection or an increase in electrical resistance with the elapse of time, while exhibiting a low electrical resistance, and which can ensure electrical conductivity with respect to a transparent conductive film and can be directly contacted to the transparent conductive film.

### Means for Solving the Problem

The outline of the present invention will be described below.
(1) A touch panel sensor is provided which includes a transparent conductive film, and a guiding wiring directly contacted to the transparent conductive film and made of an aluminum alloy film.

The aluminum alloy film comprises 0.2 to 10 atomic % in total of at least one element selected from the group X consisting of Ni and Co. The aluminum alloy film has a hardness of 2 to 15 GPa.

The above-mentioned aluminum alloy film is hereinafter referred to as a “first aluminum alloy film”.
(2) In the touch panel sensor as described in the item (1), the aluminum alloy film further comprises 0.05 atomic % or more in total of at least one element selected from the group Z consisting of a rare-earth element, Ta, Ti, Cr, Mo, W, Cu, Zn, Ge, Si, and Mg. The total content of the at least one element selected from the group X and the at least one element selected from the group Z is equal to or less than 10 atomic %.
(3) In the touch panel sensor as described in the item (1), the aluminum alloy film further comprises 0.15 atomic % or more in total of at least one element selected from the group Z consisting of a rare-earth element, Ta, Ti, Cr, Mo, W, Cu, Zn, Ge, Si, and Mg. The total content of the at least one element selected from the group X and the at least one element selected from the group Z is equal to or less than 10 atomic %.
(4) In the touch panel sensor as described in the Item (2) or (3), the aluminum alloy film further comprises the rare-earth element as at least one element selected from the group Z, and the rare-earth element content is 0.05 atomic % or more. Further, the total content of the at least one element selected from the group X and the rare-earth element is equal to or less than 10 atomic %.
(5) In the touch panel sensor as described in any one of the items (2) to (4), the rare-earth element is one or more of elements selected from the group consisting of Nd, Gd, La, Y, Ce, Pr, and Dy.
(6) In the touch panel sensor as described in any one of the items (2) to (5), the aluminum alloy film comprises Cu as at least one element selected from the group Z, the Cu content being 0.05 atomic % or more.
(7) A touch panel sensor is provided which includes a transparent conductive film, and a guiding wiring directly contacted to the transparent conductive film and made of an aluminum alloy film.

The aluminum alloy film comprises 0.02 atomic % or more in total of at least one element selected from the group X consisting of Ni and Co, and 0.2 atomic % or more of Ge. The total content of the at least one element selected from the group X and Ge is equal to or less than 10 atomic %. The aluminum alloy film has a hardness of 2 to 15 GPa.

The above-mentioned aluminum alloy film is hereinafter referred to as a “second aluminum alloy film”.
(8) In the touch panel sensor as described in the item (7), the aluminum alloy film further comprises 0.05 atomic % or more in total of at least one element selected from the group Z′ consisting of a rare-earth element, Ta, Ti, Cr, Mo, W, Cu, Zn, Si, and Mg. The total content of the at least one element selected from the group X, Ge, and the at least one element selected from the group Z′ is equal to or less than 10 atomic %.
(9) In the touch panel sensor as described in the item (8), the aluminum alloy film further comprises the rare-earth element as at least one element selected from the group Z′, the rare-earth element content being 0.05 atomic % or more. The total content of the at least one element selected from the group X, Ge, and the rare-earth element is equal to or less than 10 atomic %.
(10) In the touch panel sensor as described in the item (8) or (9), the rare-earth element is one or more of elements selected from the group consisting of Nd, Gd, La, Y, Ce, Pr, and Dy.
(11) In the touch panel sensor as described in any one of items (8) to (10), the aluminum alloy film comprises Cu as at least one element selected from the group Z′, the Cu content being 0.05 atomic % or more.
(12) In the touch panel sensor as described in any one of the items (1) to (11), the aluminum alloy film has an electrical resistivity of 50 μΩ·cm or less.
(13) In the touch panel sensor as described in any one of the items (1) to (12), the aluminum alloy film has an electrical resistivity of 25 μΩ·cm or less.
(14) In the touch panel sensor as described in any one of the items (1) to (13), the transparent conductive film is substantially made of indium tin oxide (ITO) or indium zinc oxide (IZO).

The hardness of the aluminum alloy film can be determined by a hardness measurement of films using a nano indentor. In the test, continuous stiffness measurement is performed using an XP chip by a Nano Indenter XP (soft for analysis: Test Works 4) manufactured by MTS Co., Ltd. The hardness of the aluminum alloy film can be determined by calculating an average of measured results of 15 points under conditions: press depth of 300 nm, excited vibrational frequency of 45 Hz, and amplitude of 2 nm.

### Effects of the Invention

According to the present invention, the touch panel sensor includes the guiding wiring made of the prescribed aluminum alloy film, which can reduce the electrical resistance of the wiring, while directly connecting the transparent conductive film to the wiring. Further, the touch panel sensor hardly causes poor connection of the wiring in connecting to the external device (controller), and also hardly causes disconnection or an increase in electrical resistance with the elapse of time. Therefore, the invention can provide the touch panel sensor with high reliability. The guiding wiring can be subjected to fine processes by depositing the prescribed aluminum alloy film by sputtering, and applying photolithography and etching processes. Further, the guiding wiring can also have an enhanced resistance to a developer and a resist stripper used in a manufacturing process of the touch panel sensor. Moreover, since an intervening layer for ensuring the electrical conductivity is not required to be provided between the transparent conductive layer and the aluminum alloy film, the touch panel sensor can be manufactured by the simple process without increasing steps of the process.

### BRIEF DESCRIPTION OF DRAWINGS

FIG. 1 is a diagram showing an example of the result of a hardness measurement of a film using a nano indenter;

FIG. 2 is optical micrographs showing one example of evaluation results about resistance to a resist stripper;

FIG. 3(a) is a TEM photograph of the section of an Al-2 at. % Ni-0.35 at. % La alloy film; and

FIG. 3(b) is a TEM photograph of the section of an Al-0.1 at. % Ge-0.1 at. % Gd alloy film.

### MODE FOR CARRYING OUT THE INVENTION

As mentioned above, when using pure aluminum as material for a guiding wiring in a touch panel sensor, an insulating aluminum oxide is formed at a contact interface between a transparent conductive film and a pure aluminum film, thus degrading the electrical conductivity of the interface. In the present invention, in order to improve the problems about such pure aluminum, attention has been paid to an aluminum alloy material, and components of the aluminum alloys have been studied.

As mentioned above, in some cases, stress is temporally concentrated at the end of the touch panel sensor in the normal use, and the disconnection or the like disadvantageously occurs due to the deformation of the wiring, resulting in an increase of electrical resistance or the like. In particular, when the aluminum alloy film included in the guiding wiring is excessively soft, the wiring is repeatedly deformed due to the concentration of stress, which leads to degradation, disconnection, or peeling of the wiring. In contrast, when the aluminum alloy film included in the guiding wiring is excessively hard, the wiring is hardly deformed due to the push or touch load, which causes degradation, including fine cracks or peeling. As mentioned above, the invention sets a hardness of the aluminum alloy film (first aluminum alloy film, and second aluminum alloy film) included in the guiding wiring to not less than 2 GPa (preferably 2.5 GPa or more), and not more than 15 GPa (preferably 10 GPa or less, and more preferably 8 GPa or less).

The inventors have found that an aluminum alloy film (first aluminum alloy film) comprising a certain amount of Ni and/or Co is the guiding wiring with adequate hardness which is less likely to cause disconnection or an increase in the electrical resistance, while exhibiting a low electrical resistance, and which can ensure the electrical conductivity with respect to the transparent conductive film. The first aluminum alloy film will be described below.

The reason why the guiding wiring in the touch panel sensor made of the above-mentioned aluminum alloy film can ensure the electrical conductivity with respect to the transparent conductive film is not clear enough, but is thought as follows. The formation of the aluminum oxide with a high insulating property is suppressed, and/or a conductive path is formed at an interface between the transparent conductive film and the aluminum alloy film, which can ensure the electrical conductivity with respect to the transparent conductive film. Comprising the above Ni and/or Co can achieve the film having the adequate hardness by solid solution hardening.

In this way, in order to obtain the aluminum alloy film (first aluminum alloy film) which exhibits the adequate hardness and which can ensure the low electrical resistivity and the appropriate electrical conductivity with respect to the transparent conductive film, the aluminum alloy material needs to comprise 0.2 atomic % or more (preferably, 0.3 atomic % or more) in total of at least one element selected from the group X comprising Ni and Co (hereinafter referred to as an “X-group element”). In contrast, when the aluminum alloy material comprises too much element of the above-mentioned X-group, the electrical resistivity of the aluminum alloy film itself is likely to be easily increased, and the hardness of the film is also likely to be higher than required. Therefore, the total content of at least one element selected from the group X comprising Ni and Co is equal to or less than 10 atomic % (preferably, 8 atomic % or less).

In order to achieve the aluminum alloy film having the adequate hardness, as mentioned above, preferably, the aluminum alloy film comprises an element of the X group in a prescribed amount (the element of the following Z group if necessary), and sputtering is adopted as a coating method to uniformly diffuse the X-group element thereinto. Further, the substrate temperature and an Ar gas pressure in sputtering are preferably adjusted as deposition conditions of the aluminum alloy film. As the substrate temperature becomes higher, the quality of the formed film gets close to that of a bulk, and the dense film tends to be easily formed, resulting in an increase in hardness of the film. As the Ar gas pressure becomes higher, the density of the film is decreased, and the hardness of the film tends to be reduced. Such adjustment of the deposition conditions is preferable from the viewpoint of preventing the corrosion of the film due to the nondense structure of the film.

The aluminum alloy film can comprise, in addition to the above-mentioned X-group element, at least one element selected from the group Z comprising a rare-earth element, Ta, Ti, Cr, Mo, W, Cu, Zn, Ge, Si, and Mg (hereinafter referred to as a “Z-group element”). The term “rare-earth element” used in the present invention means the group of elements which includes lanthanoids (15 elements in total from La having an atomic number of 57 to Lu having an atomic number of 71 in a periodic table), and additionally, Sc (scandium) and Y (yttrium) (note that the same goes for the following).

The above Z-group element is contained in the aluminum alloy film, whereby the film can have a more easily adjustable hardness, and a higher resistance to a strongly-alkaline developer or a resist stripper used in the manufacturing process. Specifically, the invention can prevent, for example, the elution or corrosion of aluminum in a resist development process by TMAH (tetramethylammonium hydroxide aqueous solution) or in resist removal and cleaning processes by an amine-based resist stripper, and as a result, can suppress disconnection or the like of the wiring.

In order to sufficiently exhibit the above effects, the aluminum alloy film preferably comprises 0.05 atomic % or more in total of the Z-group element. The aluminum alloy more preferably comprises 0.15 atomic % or more (much more preferably, 0.2 atomic % or more) in total of the Z-group element. However, when the Z-group element content is too much, the electrical resistivity of the aluminum alloy film itself is likely to be easily increased, and the hardness of the film is also likely to be higher than required, like the case of the X-group element. Thus, the Z-group element content is preferably set such that the total content of the X-group element and Z-group element is equal to or less than 10 atomic % (more preferably, 7 atomic % or less).

Preferably, the Z-group element includes a rare-earth element, and the rare-earth element content is 0.05 atomic % or more, and more preferably, 0.1 atomic % or more. However, when the rare-earth element content is too much, the electrical resistivity of the aluminum alloy film itself is likely to be easily increased, and the hardness of the film is also likely to be higher than required, like the case of the X-group element. Accordingly, the rare-earth element content is preferably set such that the total content of the X-group element and the rare-earth element is equal to or less than 10 atomic % (more preferably, 7 atomic % or less).

The rare-earth element is more preferably one or more of elements selected from the group comprising Nd, Gd, La, Y, Ce, Pr, and Dy.

Among the above Z-group elements, for example, the use of La, Nd, Cu, Ge, or Gd is more preferable. One or two or more of these elements are more preferably combined and used arbitrarily.

Especially Cu among the Z-group elements is contained in the film, whereby the X-group element, that is, fine precipitates of Ni and/or Co can be diffused thereinto, which can improve the resistance to the resist stripper (the resist stripper resistance).

In order to sufficiently exhibit the above effects, the Cu content is preferably 0.05 atomic % or more, and more preferably 0.1 atomic % or more.

The above-mentioned effect is remarkably exhibited by comprising a certain content or more of Cu relative to the X-group element content of the aluminum alloy film. Specifically, the effect is remarkably exhibited at a ratio of Cu (at. %) to X-group element (at. %) of 0.3 or more. The ratio of Cu (at. %) to X-group element (at. %) is more preferably 0.5 or more. Although the upper limit of the ratio of Cu (at. %) to X-group element (at. %) is not limited to a specific one, the upper limit of the Cu (at. %) to X-group element (at. %) is determined to be 2.5 based on the lower limit of the Cu content, and the upper limit of the X-group element content.

The first aluminum alloy films include, for example, an Al-2 at. % Ni-0.35 at. % La alloy film, an Al-1 at. % Ni-0.5 at. % Cu-0.35 at. % La alloy film, an Al-0.6 at. % Ni-0.5 at. % Cu-0.3 at. % La alloy film, and the like.

The invention also defines, as the aluminum alloy film to be used in the guiding wiring of the touch panel sensor, an aluminum alloy film (second aluminum alloy film) that comprises 0.02 atomic % or more in total of an X-group element (at least one element selected from the group X comprising Ni and Co), and 0.2 atomic % or more of Ge. The total content of the X-group element and Ge is equal to or less than 10 atomic %.

The X-group element contained in the second aluminum alloy film is an element effective for achieving the guiding wiring with an adequate hardness which is less likely to cause disconnection or an increase in the electrical resistance with the elapse of time, while exhibiting low electrical resistance, and which has excellent electrical conductivity with respect to the transparent conductive film. The reason why the excellent electrical conductivity can be ensured with respect to the transparent conductive film is as follows. By composite addition of Ge, (1) the formation of an aluminum oxide having a high insulating property is suppressed, like the first aluminum alloy film, and/or (2) a conductive path is formed at an interface between the transparent conductive film and the aluminum alloy film, which can ensure the electrical conductivity with respect to the transparent conductive film.

As mentioned above, the composite addition of Ge and X-group element can ensure the excellent electrical conductivity with respect to the ITO film even when the X-group element content is relatively small. From this point of view, the lower limit of the X-group element content of the second aluminum alloy film is 0.02 atomic % in total. The X-group element content of the second aluminum alloy film is preferably 0.05 atomic % or more, and more preferably 0.07 atomic % or more. In contrast, when the X-group element content is too much, the electrical resistance of the aluminum alloy film itself is likely to be easily increased, and the hardness of the film is also likely to be higher than required. Thus, the total content of the X-group element and the Ge is equal to or less than 10 atomic % (more preferably 7 atomic % or less).

Although the Ge belongs to the Z-group element contained in the first aluminum alloy film as needed, the second aluminum alloy film has an effect that a certain amount or more of Ge in the second aluminum alloy film to be described later can ensure the excellent electrical conductivity with respect to the ITO film even when the X-group element content is relatively small. Further, the Ge is an element effective for enhancing the resistance to an alkaline aqueous solution, for example, a strongly-alkaline developer, an amine-based resist removing aqueous solution, or the like. And, the Ge is also the element for contributing to improve the hardness of the aluminum alloy film to some degree.

In order to exhibit the effect of addition of the Ge, the Ge content is 0.2 atomic % or more, preferably 0.3 atomic % or more, more preferably 0.4 atomic % or more, and much more preferably 0.5 atomic % or more. In contrast, when the Ge content is too much, the electrical resistance of the aluminum alloy film itself is likely to be easily increased, and the hardness of the film is also likely to be higher than required. The total content of the Ge and the X-group element in the second aluminum alloy film is equal to or less than 10 atomic % in total (more preferably, 7 atomic % or less) as mentioned above.

The second aluminum alloy film can comprise at least one element selected from the group Z′ comprising a rare-earth element, Ta, Ti, Cr, Mo, W, Cu, Zn, Si and Mg (hereinafter referred to as a “Z′-group element”), in addition to the above X-group element and Ge.

The above Z′-group element is contained in the aluminum alloy film, like the case of the above-mentioned Z-group element, whereby the film can easily have an enhanced hardness, and a higher resistance to a strongly-alkaline developer or a resist stripper used in the manufacturing process. Specifically, the invention can prevent, for example, the elution or corrosion of aluminum in a resist development process by TMAH (tetramethylammonium hydroxide aqueous solution) or in resist removal and cleaning processes by an amine-based resist stripper, and as a result, can suppress disconnection or the like of the wiring.

In order to sufficiently exhibit the above effects, the aluminum alloy material preferably comprises 0.05 atomic % or more in total of the Z′-group element. The aluminum alloy more preferably comprises 0.1 atomic % or more. In contrast, when the Z′-group content is too much, the electrical resistivity of the aluminum alloy film itself is likely to be easily increased, and the hardness of the film is also likely to be higher than required, like the case of the X-group element or Ge. Thus, the total content of the Z′-group element content is set such that a total content of the X-group element, Ge, and the Z′-group element is preferably equal to or less than 10 atomic % (more preferably, 7 atomic % or less).

The Z′-group elements comprise a rare-earth element, and the rare-earth element content is preferably 0.05 atomic % or more, and more preferably 0.1 atomic % or more. In contrast, when the rare-earth element content is too much, the electrical resistivity of the aluminum alloy film itself is likely to be easily increased, and the hardness of the film is also likely to be higher than required, like the case of the X-group element or Ge. Thus, the rare-earth element content is set such that the total content of the X-group element, Ge and the rare-earth element is preferably equal to or less than 10 atomic % (more preferably, 7 atomic % or less).

The rare-earth element is preferably one or more of elements selected from the group comprising Nd, Gd, La, Y, Ce, Pr, and Dy.

The second aluminum alloy films comprising the above X-group element, Ge, and the rare-earth element include, for example, an Al-0.1 at. % X-group element-Ge-0.3 at. % or more of Nd or La alloy film (for example, Al-0.1 at. % Ni-0.5 at. % Ge-0.5 at. % Nd alloy film), an Al-0.2 at. % Ni-0.5 at. % Ge-0.2 at. % La alloy film, an Al-0.2 at. % Ni-0.5 at. % Ge-0.2 at. % La alloy film, an Al-0.1 at. % Ni-0.5 at. % Ge-0.3 at. % Nd alloy film, an Al-0.2 at. % Co-0.5 at. % Ge-0.2 at. % La alloy film, and an Al-0.1 at. % Co-0.5 at. % Ge-0.3 at. % Nd alloy film.

Especially Cu among the Z′-group elements is contained in the film, whereby fine precipitates of the X-group element, namely, Ni and/or Co can be diffused thereinto, which results in improved resistance to the resist stripper.

In order to sufficiently exhibit the above effects, the Cu content is preferably 0.05 atomic % or more, and more preferably 0.07 atomic % or more.

The above effects are remarkably exhibited by comprising the certain content or more of Cu with respect to the X-group element content contained in the second aluminum alloy film. Specifically, when Cu (at. %)/X-group element (at. %) is 0.3 or more, the effect is remarkably exhibited. The Cu (at. %)/X-group element (at. %) is more preferably 0.5 or more. Although the upper limit of the Cu (at. %)/X-group element (at. %) is not limited thereto, the upper limit of the Cu (at. %)/X-group element (at. %) is 25 based on the lower limit of the Cu content and the upper limit of the X-group element content.

In order to obtain the second aluminum alloy film having an adequate hardness, preferably, the prescribed amount of X-group element and Ge (Z′-group element if necessary) is contained, and the substrate temperature and the Ar gas pressure in sputtering are adjusted as deposition conditions of the aluminum alloy film. As the substrate temperature becomes higher, the quality of the formed film gets close to that of a bulk, and the dense film tends to be easily formed, resulting in an increase in hardness of the film. As the Ar gas pressure becomes higher, the density of the film tends to be decreased, resulting in reduction in hardness of the film. Such adjustment of the deposition conditions is preferable from the viewpoint of suppressing the corrosion of the film due to the nondense structure of the film.

The first aluminum alloy film and the second aluminum alloy film according to the invention can also have an improved hardness by making fine Al crystal particles. Addition of the alloy element according to a thermal history applied to the aluminum alloy film in the manufacturing process is effective for making the Al crystal particles finer. When the thermal history of the aluminum alloy film (for example, the heat treatment temperature in forming an insulating film (SiN film) after deposition of the aluminum alloy film) is high (of about 250° C. or more), the Al crystal particles can be made finer by adding a rare-earth element or a high-melting-point metal (Ta, Ti, Cr, Mo, W) as the alloy element. When the thermal history of the aluminum alloy film is low (of about 200° C. or less), the Al crystal particles can be made finer by adding Ge as the alloy element.

The compositions of the first aluminum alloy film and the second aluminum alloy film (hereinafter collectively referred to as an “aluminum alloy film”) according to the invention are as noted above, with a balance of aluminum and inevitable impurities. The inevitable impurities can comprise, for example, inevitable impurities (for example, oxygen (O) or the like) mixed in manufacturing steps or the like of the aluminum alloy film.

With the above structure, the aluminum alloy film having an electrical resistivity of 50 μΩ·cm or less, preferably 25 μΩ·cm or less (more preferably, 20 μΩ·cm or less) can be achieved as the aluminum alloy film included in the guiding wiring of the touch panel sensor.

The invention does not define even a method for forming the aluminum alloy film, but the aluminum alloy film is preferably formed by sputtering from the viewpoint of narrowing a line or uniformizing alloy components within the film. Alternatively, the aluminum alloy film can be formed by vapor deposition. However, the sputtering is better from the standpoint of easily controlling the amount of an additional element.

The touch panel sensor of the invention does not particularly limit other components except for the guiding wiring directly contacted to the transparent conductive film and made of the aluminum alloy film, and thus can be applied to any other structure known in the art.

For example, the resistance film type touch panel sensor can be manufactured in the following way. That is, after forming the transparent conductive film over the substrate, the resist application, exposure to light, development, and etching are performed on the substrate in that order. Then, the aluminum alloy film is formed, and the resist application, exposure to light, development, and etching are further performed to form the guiding wiring. Then, the upper electrode can be formed by forming an insulating film or the like so as to cover the wiring. The transparent conductive film is formed over the substrate, and the same photolithography as that for formation of the upper electrode is performed. Then, the lower electrode can be formed by forming the guiding wiring made of the aluminum alloy film, forming an insulating film so as to cover the wiring, and forming a micro dot spacer or the like, in the same way as that of the upper electrode. Thereafter, the above-mentioned upper electrode, lower electrode, and a tail part separately formed are bonded together thereby to manufacture the touch panel sensor.

The transparent conductive film in use is not limited to a specific one, but can be made of indium tin oxide (ITO) or indium zinc oxide (IZO) by way of representative example. The substrate (transparent substrate) in use can be a generally-used one, such as glass, a polycarbonate-based one, or polyamide-based one. For example, glass can be used as the substrate of the lower electrode serving as a fixed electrode, and a polycarbonate-based film or the like can be used as the substrate of the upper electrode which is required to have plasticity.

The touch panel sensor of the invention can be used as a capacitance type or an ultrasonic surface elastic wave type touch panel sensor, in addition to the resistance film type one.

### Examples

The following tests, measurement, and evaluation have been executed so as to make sure that the aluminum alloy film of the invention is suitable for use in the guiding wiring of the touch panel sensor. Specifically, the hardness measurement, evaluation of electrical conductivity with respect to the transparent conductive film, measurement of an electrical resistivity of the aluminum alloy film, and evaluation of resistance to the developer or resist stripper were carried out.

The invention will be described more specifically by way of examples, but is not limited to the examples disclosed. It is apparent that various appropriate modifications can be made to the examples below within the spirit of the invention described above and below. These modifications are intended to fall within the technical scope of the invention.

### Example 1

### Hardness Measurement Using Nano Indenter

An alkali-free glass plate (of 0.7 mm in thickness and 4 inches in diameter) was prepared as a substrate. Each aluminum alloy film shown in Tables 1 to 6 (each having a thickness of about 300 nm) was deposited on the surface of the substrate by a DC magnetron sputtering method. Once the atmosphere in a chamber was set at an ultimate pressure of 3×10⁻⁶ Torr before deposition, the deposition was performed using a disk-like target made of the same composition as that of each aluminum alloy film and having a diameter of 4 inches on the following conditions. The composition of the aluminum alloy film formed was identified by an inductively coupled plasma (ICP) mass spectrometry.

### (Sputtering Conditions)

Ar Gas Pressure: 2 mTorr
Ar Gas Flow Rate: 30 sccm
Sputtering Power: 260 W
Substrate Temperature: room temperature

The film hardness measurement was performed by the nano indenter using the aluminum alloy film obtained as described above. In this measurement, continuous stiffness measurement was performed using an XP chip of each aluminum alloy film by a Nano Indenter XP (soft for analysis: Test Works 4) manufactured by MTS Co.Ltd. An average of measured results of 15 points of each aluminum alloy film was determined under the following conditions: press depth of 300 nm, excited vibrational frequency of 45 Hz, and amplitude of 2 nm. The same type of measurement was performed on a sample having a pure aluminum film formed thereat, instead of the aluminum alloy film.

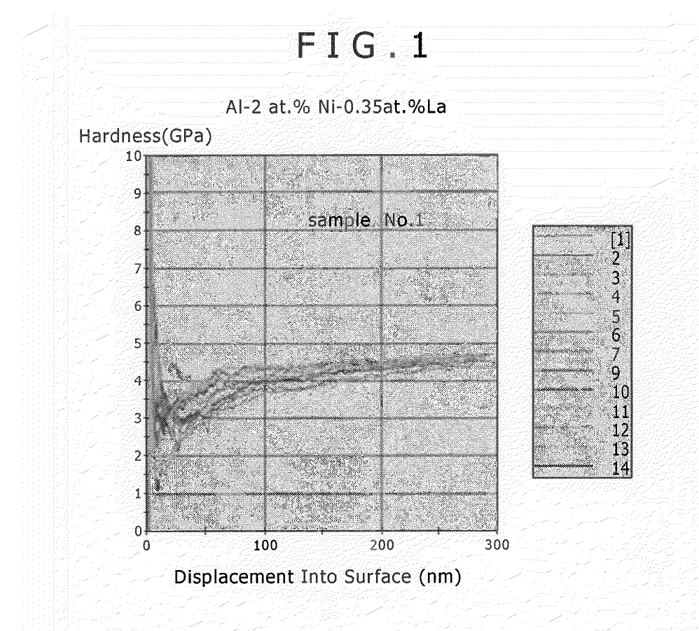

One example of the measurement result was shown in FIG. 1. (Note that the sample number “No.” shown in FIG. 1 is given for convenience of measurement, and does not correspond to the number “No.” shown in Tables 1 to 6.). FIG. 1 shows the case of Al-2 at. % Ni-0.35 at. % La alloy film. Also, the same measurement was performed on the aluminum alloy films and the pure aluminum film shown in Tables 1 to 6.

The measurement results are shown in Tables 1 to 6. The following can be considered from Tables 1 to 6. Together with the addition of the alloy element (the x-group element and the z-group element of the first aluminum alloy film, and the x-group element, Ge, and the rare-earth element of the second aluminum alloy film), the hardness of the aluminum alloy film tends to be increased. In order to set the hardness of the first aluminum alloy film to 10 GPa or less in adding the Z-group element thereto, the upper limit of the X-group element content and the Z-group element content needs to be 10 atomic %.

TABLE 1

| | | Transpar- | Hard- | Al alloy/ITO | ITO/Al alloy | ITO/Al alloy | Electrical | Resis- | Resis- | |
|---|---|---|---|---|---|---|---|---|---|---|
| | | ent con- | ness of | 80 μm square | 80 μm square | 80 μm square | resistivity | tance to | tance to | Total |
| | | ductive | film | as-depo | as-depo | after anneal^{} | as-depo | resist | devel- | eval- |
| No. | Composition | film | (GPa) | (Ω) | (Ω) | (Ω) | (μΩ · cm) | stripper | oper | uation |
| 1 | Al—0.05Ni—0.35La | ITO | 2.25 | 584 | 867 | 578 | 5.0 | B | A | B |
| | | IZO | | 526 | 943 | 629 | | | | B |
| 2 | Al—0.1Ni—0.35La | ITO | 2.47 | 276 | 357 | 238 | 5.2 | B | A | B |
| | | IZO | | 254 | 429 | 286 | | | | B |
| 3 | Al—0.3Ni—0.35La | ITO | 3.19 | 36 | 27 | 18 | 6.0 | B | A | A |
| | | IZO | | 65 | 30 | 20 | | | | A |
| 4 | Al—0.5Ni—0.35Nd | ITO | 3.78 | 23 | 24 | 16 | 6.7 | B | A | A |
| | | IZO | | 24 | 26 | 17 | | | | A |
| 5 | Al—1Ni—0.35Y | ITO | 4.96 | 22 | 16 | 11 | 8.6 | B | A | A |
| | | IZO | | 32 | 17 | 11 | | | | A |
| 6 | Al—2Ni—0.35Gd | ITO | 6.72 | 13 | 9 | 10 | 12.3 | B | A | A |
| | | IZO | | 26 | 12 | 11 | | | | A |
| 7 | Al—1Ni—0.35Cu | ITO | 4.80 | 26 | 14 | 12 | 8.1 | B | A | A |
| | | IZO | | 48 | 15 | 10 | | | | A |
| 8 | Al—0.5Ni—0.35Mg | ITO | 3.34 | 27 | 26 | 17 | 5.6 | B | A | A |
| | | IZO | | 34 | 27 | 18 | | | | A |
| 9 | Al—1Ni—0.35Ge | ITO | 4.64 | 32 | 17 | 11 | 7.4 | B | A | A |
| | | IZO | | 48 | 19 | 13 | | | | A |
| 10 | Al—2Ni—0.35Si | ITO | 6.52 | 19 | 9 | 9 | 11.2 | B | A | A |
| | | IZO | | 37 | 10 | 11 | | | | A |
| 11 | Al—0.3Ni—0.35In | ITO | 2.63 | 26 | 15 | 12 | 4.8 | D | C | B |
| | | IZO | | 48 | 15 | 10 | | | | B |
| 12 | Al—0.5Ni—0.35Sr | ITO | 3.34 | 27 | 26 | 17 | 5.6 | D | C | B |
| | | IZO | | 34 | 27 | 18 | | | | B |
| 13 | Al—3Ni—0.3Ge | ITO | 7.9 | 24 | 10 | 8 | 14.9 | B | A | A |
| | | IZO | | 26 | 7 | 8 | | | | A |
| 14 | Al—10Ni—0.35Si | ITO | 14.37 | 19 | 9 | 10 | 41.2 | B | A | A |
| | | IZO | | 37 | 10 | 11 | | | | A |
| 15 | Al—1Ni—0.35Pt | ITO | 5.32 | 32 | 17 | 11 | 8.7 | D | C | B |
| | | IZO | | 48 | 19 | 13 | | | | B |

^{}Heat treatment at 250° C. for 30 minutes

TABLE 2

| | | Transpar- | Hard- | Al alloy/ITO | ITO/Al alloy | ITO/Al alloy | Electrical | Resis- | Resis- | |
|---|---|---|---|---|---|---|---|---|---|---|
| | | ent con- | ness of | 80 μm square | 80 μm square | 80 μm square | resistivity | tance to | tance to | Total |
| | | ductive | film | as-depo | as-depo | after anneal * | as-depo | resist | devel- | eval- |
| No. | Composition | film | (GPa) | (Ω) | (Ω) | (Ω) | (μΩ · cm) | stripper | oper | uation |
| 16 | Al—2Ni—0.35Ba | ITO | 6.48 | 19 | 9 | 9 | 11.2 | D | C | B |
| | | IZO | | 37 | 10 | 11 | | | | B |
| 17 | Al—1Ni—0.05La | ITO | 4.65 | 22 | 15 | 10 | 7.6 | C | B | A |
| | | IZO | | 32 | 13 | 9 | | | | A |
| 18 | Al—1Ni—0.1Mg | ITO | 4.61 | 19 | 15 | 10 | 7.4 | C | B | A |
| | | IZO | | 35 | 18 | 12 | | | | A |
| 19 | Al—1Ni—0.5La | ITO | 5.11 | 21 | 16 | 11 | 9.1 | B | A | A |
| | | IZO | | 30 | 18 | 12 | | | | A |
| 20 | Al—1Ni—1Cu | ITO | 5.22 | 26 | 14 | 9 | 9.4 | A | A | A |
| | | IZO | | 31 | 18 | 12 | | | | A |
| 21 | Al—1Ni—5La | ITO | 8.40 | 24 | 16 | 11 | 23.8 | B | A | A |
| | | IZO | | 31 | 17 | 11 | | | | A |
| 23 | Al—1Ni—0.05Gd | ITO | 4.65 | 22 | 20 | 13 | 7.6 | C | B | A |
| | | IZO | | 34 | 17 | 11 | | | | A |
| 24 | Al—1Ni—0.1Nd | ITO | 4.70 | 24 | 16 | 11 | 7.8 | C | B | A |
| | | IZO | | 31 | 19 | 13 | | | | A |
| 25 | Al—1Ni—0.5Fe | ITO | 6.20 | 24 | 17 | 11 | 10.4 | B | A | A |
| | | IZO | | 31 | 14 | 9 | | | | A |
| 26 | Al—1Ni—0.5La—0.2Ti | ITO | 5.15 | 26 | 16 | 11 | 9.1 | B | A | A |
| | | IZO | | 31 | 22 | 16 | | | | A |
| 27 | Al—1Ni—0.35La—0.5Mg | ITO | 5.00 | 25 | 19 | 13 | 8.6 | B | A | A |
| | | IZO | | 38 | 23 | 15 | | | | A |
| 28 | Al—1Ni—0.5Cu—0.3La | ITO | 5.21 | 18 | 18 | 12 | 9.4 | B | A | A |
| | | IZO | | 37 | 17 | 11 | | | | A |
| 29 | Al—0.05Co—0.35Nd | ITO | 2.30 | 624 | 947 | 631 | 5.1 | B | A | B |
| | | IZO | | 583 | 1075 | 717 | | | | B |
| 30 | Al—0.1Co—0.35Nd | ITO | 2.55 | 314 | 482 | 321 | 5.3 | B | A | B |
| | | IZO | | 297 | 649 | 433 | | | | B |

* Heat treatment at 250° C. for 30 minutes

TABLE 3

| | | Transpar- | Hard- | Al alloy/ITO | ITO/Al alloy | ITO/Al alloy | Electrical | Resis- | Resis- | |
|---|---|---|---|---|---|---|---|---|---|---|
| | | ent con- | ness of | 80 μm square | 80 μm square | 80 μm square | resistivity | tance to | tance to | Total |
| | | ductive | film | as-depo | as-depo | after anneal^{} | as-depo | resist | devel- | eval- |
| No. | Composition | film | (GPa) | (Ω) | (Ω) | (Ω) | (μΩ · cm) | stripper | oper | uation |
| 31 | Al—0.3Co—0.35Nd | ITO | 3.39 | 36 | 54 | 36 | 6.1 | B | A | A |
| | | IZO | | 69 | 58 | 39 | | | | A |
| 32 | Al—0.5Co—0.35Gd | ITO | 4.06 | 25 | 32 | 21 | 7.0 | B | A | A |
| | | IZO | | 31 | 35 | 23 | | | | A |
| 33 | Al—1Co—0.35La | ITO | 5.37 | 26 | 28 | 19 | 9.1 | B | A | A |
| | | IZO | | 38 | 30 | 20 | | | | A |
| 34 | Al—2Co—0.35Y | ITO | 7.32 | 16 | 21 | 14 | 13.4 | B | A | A |
| | | IZO | | 31 | 25 | 17 | | | | A |
| 35 | Al—0.3Co—0.35Ti | ITO | 2.96 | 39 | 54 | 36 | 5.0 | B | A | A |
| | | IZO | | 73 | 58 | 39 | | | | A |
| 36 | Al—0.5Co—0.35Ta | ITO | 3.71 | 25 | 32 | 21 | 5.8 | B | A | A |
| | | IZO | | 31 | 35 | 23 | | | | A |
| 37 | Al—1Co—0.35Cu | ITO | 5.24 | 26 | 28 | 19 | 8.7 | A | A | A |
| | | IZO | | 38 | 30 | 20 | | | | A |
| 38 | Al—2Co—0.3Cr | ITO | 7.13 | 16 | 21 | 14 | 12.3 | B | B | A |
| | | IZO | | 31 | 25 | 17 | | | | A |
| 39 | Al—0.3Ni—0.2Co—0.35La | ITO | 3.94 | 23 | 28 | 19 | 6.8 | B | A | A |
| | | IZO | | 29 | 30 | 20 | | | | A |
| 40 | Al—0.2Ni—0.6Co—0.35Y | ITO | 4.80 | 25 | 22 | 15 | 8.2 | B | A | A |
| | | IZO | | 37 | 25 | 17 | | | | A |
| 41 | Al—0.5Ni—0.5Co—0.35Nd | ITO | 5.17 | 24 | 20 | 13 | 8.9 | B | A | A |
| | | IZO | | 35 | 23 | 15 | | | | A |
| 42 | Al—0.5Ni—1Co—0.35Gd | ITO | 6.25 | 15 | 16 | 11 | 11.0 | B | A | A |
| | | IZO | | 30 | 18 | 12 | | | | A |
| 43 | Al | ITO | 0.76 | — | — | — | 3.3 | A | A | B |
| | | IZO | | — | — | — | | | | B |

^{}Heat treatment at 250° C. for 30 minutes

TABLE 4

| | | Transpar- | Hard- | Al alloy/ITO | ITO/Al alloy | ITO/Al alloy | Electrical | Resis- | Resis- | |
|---|---|---|---|---|---|---|---|---|---|---|
| | | ent con- | ness of | 80 μm square | 80 μm square | 80 μm square | resistivity | tance to | tance to | Total |
| | | ductive | film | as-depo | as-depo | after anneal * | as-depo | resist | devel- | eval- |
| No. | Composition | film | (GPa) | (Ω) | (Ω) | (Ω) | (μΩ · cm) | stripper | oper | uation |
| 44 | Al—0.05Ni | ITO | 1.27 | 33 | 852 | 568 | 3.9 | B | A | B |
| | | IZO | | 58 | 934 | 623 | | | | B |
| 45 | Al—0.1Co | ITO | 1.76 | 31 | 346 | 231 | 4.1 | B | A | B |
| | | IZO | | 60 | 422 | 281 | | | | B |
| 46 | Al—0.3Ni | ITO | 2.60 | 32 | 29 | 19 | 4.8 | B | A | A |
| | | IZO | | 59 | 34 | 23 | | | | A |
| 47 | Al—0.2Ni—0.2Co | ITO | 3.11 | 22 | 27 | 18 | 5.3 | B | A | A |
| | | IZO | | 25 | 30 | 20 | | | | A |
| 48 | Al—1Ni | ITO | 4.60 | 21 | 16 | 11 | 7.4 | B | A | A |
| | | IZO | | 30 | 17 | 12 | | | | A |
| 49 | Al—2Co | ITO | 7.08 | 14 | 9 | 10 | 12.3 | B | A | A |
| | | IZO | | 23 | 12 | 11 | | | | A |
| 50 | Al—2Ni—2Co | ITO | 9.55 | 12 | 8 | 11 | 19.8 | B | A | A |
| | | IZO | | 22 | 11 | 13 | | | | A |
| 51 | Al—7Ni | ITO | 12.02 | 10 | 9 | 10 | 29.9 | B | A | A |
| | | IZO | | 21 | 11 | 12 | | | | A |
| 52 | Al—10Ni | ITO | 14.38 | 10 | 9 | 10 | 41.1 | B | A | A |
| | | IZO | | 21 | 11 | 12 | | | | A |
| 53 | Al—15Ni | ITO | 17.57 | 10 | 9 | 10 | 59.8 | B | A | B |
| | | IZO | | 21 | 11 | 12 | | | | B |
| 54 | Al—5Ni—0.35La | ITO | 10.33 | 12 | 8 | 11 | 23.5 | B | A | A |
| | | IZO | | 22 | 11 | 13 | | | | A |
| 55 | Al—7Ni—0.35La | ITO | 12.16 | 10 | 9 | 10 | 31.0 | B | A | A |
| | | IZO | | 21 | 11 | 12 | | | | A |

* Heat treatment at 250° C. for 30 minutes.

TABLE 5

| | | Transpar- | Hard- | Al alloy/ITO | ITO/Al alloy | ITO/Al alloy | Electrical | Resis- | Resis- | |
|---|---|---|---|---|---|---|---|---|---|---|
| | | ent con- | ness of | 80 μm square | 80 μm square | 80 μm square | resistivity | tance to | tance to | Total |
| | | ductive | film | as-depo | as-depo | after anneal^{} | as-depo | resist | devel- | eval- |
| No. | Composition | film | (GPa) | (Ω) | (Ω) | (Ω) | (μΩ · cm) | stripper | oper | uation |
| 56 | Al—0.05Co—0.35La | ITO | 2.30 | 38 | 884 | 589 | 5.1 | B | A | B |
| | | IZO | | 67 | 1028 | 685 | | | | B |
| 57 | Al—0.1Co—0.35La | ITO | 2.55 | 36 | 396 | 264 | 5.3 | B | A | B |
| | | IZO | | 66 | 475 | 317 | | | | B |
| 58 | Al—0.3Co—0.35La | ITO | 3.39 | 33 | 32 | 21 | 6.1 | B | A | A |
| | | IZO | | 61 | 37 | 25 | | | | A |
| 59 | Al—0.5Co—0.35Nd | ITO | 4.05 | 28 | 29 | 19 | 7.0 | B | A | A |
| | | IZO | | 58 | 34 | 23 | | | | A |
| 60 | Al—1Co—0.35Y | ITO | 5.37 | 25 | 24 | 16 | 9.1 | B | A | A |
| | | IZO | | 53 | 29 | 19 | | | | A |
| 61 | Al—2Co—0.35Gd | ITO | 7.32 | 21 | 17 | 10 | 13.4 | B | A | A |
| | | IZO | | 47 | 19 | 11 | | | | A |
| 62 | Al—5Co—0.35La | ITO | 11.31 | 18 | 17 | 10 | 26.3 | B | A | A |
| | | IZO | | 42 | 18 | 11 | | | | A |
| 63 | Al—7Co—0.35La | ITO | 13.32 | 17 | 16 | 10 | 34.9 | B | A | A |
| | | IZO | | 38 | 18 | 11 | | | | A |
| 64 | Al—0.1Ni—0.1Co—0.35La | ITO | 2.93 | 35 | 47 | 31 | 5.6 | B | A | A |
| | | IZO | | 62 | 56 | 37 | | | | A |
| 65 | Al—0.5Ni—0.5Co—0.35La | ITO | 5.17 | 24 | 24 | 16 | 8.9 | B | A | A |
| | | IZO | | 36 | 33 | 22 | | | | A |
| 66 | Al—1Ni—0.2Co—0.35Nd | ITO | 5.44 | 22 | 22 | 15 | 9.4 | B | A | A |
| | | IZO | | 32 | 28 | 19 | | | | A |
| 67 | Al—0.5Ni—1Co—0.35Y | ITO | 6.25 | 18 | 20 | 13 | 11.0 | B | A | A |
| | | IZO | | 28 | 25 | 17 | | | | A |
| 68 | Al—0.05Ni—0.5Ge—0.35La | ITO | 2.29 | 33 | 127 | 85 | 5.0 | A | A | A |
| | | IZO | | 58 | 138 | 92 | | | | A |
| 69 | Al—0.1Ni—0.5Ge—0.35La | ITO | 2.50 | 28 | 43 | 29 | 5.2 | A | A | A |
| | | IZO | | 45 | 49 | 33 | | | | A |
| 70 | Al—0.3Ni—1Ge—0.35La | ITO | 3.25 | 22 | 36 | 24 | 6.0 | B | A | A |
| | | IZO | | 38 | 40 | 27 | | | | A |
| 71 | Al—0.5Ni—1Ge—0.35Nd | ITO | 3.83 | 21 | 24 | 16 | 6.7 | B | A | A |
| | | IZO | | 30 | 27 | 18 | | | | A |
| 72 | Al—1Ni—0.5Ge—0.35Y | ITO | 4.98 | 22 | 23 | 15 | 8.6 | B | A | A |
| | | IZO | | 28 | 28 | 19 | | | | A |
| 73 | Al—2Ni—0.2Ge—0.35Gd | ITO | 6.72 | 20 | 11 | 10 | 12.3 | B | A | A |
| | | IZO | | 25 | 14 | 11 | | | | A |

^{}Heat treatment at 250° C. for 30 minutes

TABLE 6

| | | Transpar- | Hard- | Al alloy/ITO | ITO/Al alloy |
|---|---|---|---|---|---|
| | | ent con- | ness of | 80 μm square | 80 μm square |
| | | ductive | film | as-depo | as-depo |
| No. | Composition | film | (GPa) | (Ω) | (Ω) |
| 74 | Al—0.05Ni—0.5Co—0.5Ge—0.35Nd | ITO | 4.20 | 20 | 23 |
| | | IZO | | 27 | 26 |
| 75 | Al—0.1Ni—0.1Co—0.5Ge—0.35La | ITO | 2.96 | 26 | 38 |
| | | IZO | | 41 | 45 |
| 76 | Al—0.3Ni—0.1Co—0.5Ge—0.35Nd | ITO | 3.58 | 21 | 26 |
| | | IZO | | 33 | 28 |
| 78 | Al—0.1Ni—0.5Ge—0.3La | ITO | 2.40 | 28 | 42 |
| | | IZO | | 45 | 46 |
| 79 | Al—0.1Ni—0.5Ge—0.5La | ITO | 2.78 | 28 | 43 |
| | | IZO | | 44 | 47 |
| 80 | Al—0.5Ni—1Nd | ITO | 4.55 | 29 | 24 |
| | | IZO | | 45 | 26 |
| 81 | Al—1Co—2Y | ITO | 6.39 | 29 | 16 |
| | | IZO | | 45 | 17 |
| 82 | Al—1Ni—1Co—3Gd | ITO | 8.69 | 30 | 9 |
| | | IZO | | 46 | 12 |
| 83 | Al—5Ni—5La | ITO | 12.36 | 30 | 9 |
| | | IZO | | 47 | 12 |
| 84 | Al—7Ni—7La | ITO | 14.61 | 31 | 9 |
| | | IZO | | 48 | 12 |
| 85 | Al—5Ni—0.35Ge | ITO | 7.90 | 32 | 11 |
| | | IZO | | 48 | 8 |
| 86 | Al—2Ni—0.35La | ITO | 6.72 | 13 | 9 |
| | | IZO | | 26 | 12 |
| 87 | Al—0.1Ge—0.1Gd | ITO | 1.49 | 584 | 867 |
| | | IZO | | 526 | 943 |

| | ITO/Al alloy | Electrical | Resis- | Resis- | |
|---|---|---|---|---|---|
| | 80 μm square | resistivity | tance to | tance to | Total |
| | after anneal^{} | as-depo | resist | devel- | eval- |
| No. | (Ω) | (μΩ · cm) | stripper | oper | uation |
| 74 | 15 | 7.2 | A | A | A |
| | 17 | | | | A |
| 75 | 25 | 5.6 | A | A | A |
| | 30 | | | | A |
| 76 | 17 | 6.4 | B | A | A |
| | 19 | | | | A |
| 78 | 28 | 5.1 | B | A | A |
| | 31 | | | | A |
| 79 | 29 | 5.7 | A | A | A |
| | 31 | | | | A |
| 80 | 16 | 8.8 | B | A | A |
| | 17 | | | | A |
| 81 | 11 | 14.0 | B | A | A |
| | 12 | | | | A |
| 82 | 10 | 21.6 | B | A | A |
| | 11 | | | | A |
| 83 | 10 | 38.8 | B | A | A |
| | 11 | | | | A |
| 84 | 10 | 52.8 | B | A | B |
| | 11 | | | | B |
| 85 | 7 | 14.9 | B | A | A |
| | 9 | | | | A |
| 86 | 10 | 12.3 | B | A | A |
| | 11 | | | | A |
| 87 | 578 | 4.1 | B | A | B |
| | 629 | | | | B |

^{}Heat treatment at 250° C. for 30 minutes

### Example 2

### Evaluation of Electrical Conductivity of Structure Including Transparent conductive film as Lower Part and Aluminum Alloy Film as Upper Part

When a transparent conductive film and each aluminum alloy film were stacked in that order, a contact resistance of a contact part between both films was measured as described later, so that the electrical conductivity of the aluminum alloy film with respect to the transparent conductive film in the stacked structure was evaluated.

An alkali-free glass plate (of 0.7 mm in thickness and 4 inches in diameter) was prepared as a substrate. An ITO film or IZO film (each having a thickness of 50 nm or less) serving as the transparent conductive oxide film was deposited on the surface of the substrate at room temperature by the DC magnetron sputtering method, and was patterned by photolithography and etching. Then, each of the aluminum alloy films (each having a thickness of about 300 nm) shown in Tables 1 to 6 was deposited thereover in the same way as in Example 1. Then, the resist application, exposure to light, and development by a tetramethylammonium hydroxide aqueous solution (TMAH) were performed on the aluminum alloy film thereby to form a Kelvin pattern (in which a contact area between the transparent conductive film and the aluminum alloy film was 80 μm square).

By using the Kelvin pattern, a contact resistance of an interface between the transparent conductive film and the aluminum alloy film was measured by a four-terminal Kelvin method. The measurement used a four-terminal manual prober, and a semiconductor parameter analyzer “HP4156A” (manufactured by Hewlett-Packard Company).

The sample having a contact resistance of 150Ω or less was determined to be good, while the sample having a contact resistance exceeding 150Ω was determined to be bad. Although the same measurement was also intended to be performed on the sample having a pure aluminum film formed thereat instead of the aluminum alloy film, the sample having the pure aluminum film formed thereat cannot be measured due to poor electric contact.

The measurement results are also shown in Tables 1 to 6. As can be seen from Tables 1 to 6, the X-group element content needs to be 0.2 atomic % or more so as to ensure the electrical conductivity with respect to the transparent conductive film.

### Example 3

### Evaluation of Electrical Conductivity of Structure Including Aluminum Alloy Film as Lower Part and Transparent conductive film as Upper Part

When each aluminum alloy film and a transparent conductive film were stacked in that order, a contact resistance of a contact part between both films was measured as described later thereby to evaluate the electrical conductivity of the aluminum alloy film with respect to the transparent conductive film in the stacked structure.

An alkali-free glass plate (of 0.7 mm in thickness and 4 inches in diameter) was prepared as a substrate. An aluminum alloy film (each having a thickness of about 300 nm) shown in Tables 1 to 6 was deposited in the same way as that of Example 1. Then, these samples were subjected to heat treatment at 270° C. for 10 minutes, while simulating a thermal history in a manufacturing process. The heat treatment atmosphere was vacuum (vacuum degree: 3×10⁻⁴ Pa or less), or nitrogen atmosphere. Thereafter, the patterning was performed by photolithography and etching. Then, like Example 2, an ITO film or IZO film (of 50 nm or less in thickness) was deposited thereover and subjected to photolithography and etching thereby to form a Kelving pattern (in which a contact area between the transparent conductive film and the aluminum alloy film was 80 μm square). A contact resistance of the aluminum alloy film was measured by the four-terminal Kelvin method in the same way as Example 2.

The measurement of the contact resistance was performed on the Kelvin pattern as-deposited in the above-mentioned way, and the other Kelvin pattern formed in the following way. That is, the other Kelvin pattern was formed by applying heat treatment to the deposited aluminum alloy film at 250° C. for 30 minutes in vacuum or inert gas atmosphere, and applying another heat treatment thereto at 270° C. for 10 minutes while simulating the above-mentioned thermal history.

The sample having a contact resistance of 150Ω or less was determined to be good, while the sample having a contact resistance exceeding 150Ω was determined to be bad. Although the same measurement was also intended to be performed on the sample having a pure aluminum film formed thereat instead of the aluminum alloy film, the sample having the pure aluminum film formed thereat cannot be measured due to poor electric contact.

The measurement results are also shown in Tables 1 to 6. As can be seen from Tables 1 to 6, in order to ensure the electrical conductivity with respect to the transparent conductive film, in the first aluminum alloy film, the X-group element content needs to be 0.2 atomic % or more. Further, in the second aluminum alloy film, the X-group element content needs to be 0.02 atomic % or more, and the Ge content also needs to be 0.2 atomic % or more.

From Tables 1 to 6, it can be considered that the sample subjected to the heat treatment at 250° C. for 30 minutes after forming the aluminum alloy film tends to decrease the contact resistance with respect to the transparent conductive film, as compared to the sample not subjected to the heat treatment.

This is because the alloy element contained in the aluminum alloy is precipitated outside the aluminum crystal grain to form a conductive path near the interface between the transparent conductive film and the aluminum alloy film.

The application of the heat treatment has the following merits. That is, when the aluminum alloy film is subjected to the heat treatment at a temperature of 250° C. or more in vacuum or inert gas atmosphere before a resist developing step by TMAH for patterning the guiding wiring, the composition of the aluminum alloy can change to reduce or eliminate voids, such as a pinhole or a penetration grain boundary. The aluminum alloy film is formed while heating the substrate to a temperature of 100° C. or more, and subjected to the heat treatment at a temperature of 100° C. or more in vacuum or inert gas atmosphere before the resist developing process by the TMAH for patterning the guiding wiring. Thus, the coverage of the aluminum alloy film (particularly, the coverage at the edge of a pattern of the transparent conductive oxide film) is improved, which can prevent corrosion due to impregnation with a chemical solution, such as a developer.

Further, the heat treatment can be performed to suppress galvanic corrosion. The galvanic corrosion is caused in the case of a large difference in electrode potential between different kinds of metals, for example, between the transparent conductive oxide film, such as ITO, and the pure aluminum film. For example, an electrode potential with respect to the Ag/AgCl standard electrode in a tetramethylammnonium hydroxide (TMAH) aqueous solution which is an alkali developer is about −0.17 V for the amorphous ITO, and about −0.19 V for the polycrystalline ITO, but about −1.93 V for the pure aluminum, which is very low. Further, pure aluminum is apt to be oxidized very easily as mentioned above. Thus, a battery reaction occurs at an interface between the pure aluminum film and the transparent conductive oxide film in immersion in the TMAH aqueous solution to cause corrosion. When the TMAH aqueous solution penetrates the interface to the transparent conductive oxide film along the pin holes or penetration grain boundary caused in the aluminum alloy film, the galvanic corrosion is possibly caused at the interface. In this case, various inconveniences may be caused which include, for example, blackening of the transparent conductive oxide film, blackening of pixels, poor formation of a pattern, such as thinning or disconnection of wiring, an increase in contact resistance between the pure aluminum film and the transparent conductive oxide film, and failure of display (lighting), or the like.

In the invention, the above-mentioned heat treatment can be performed for suppressing the galvanic corrosion. The reason for this is as follows. That is, the heat treatment promotes precipitation of Ni and/or Co of the aluminum alloy film, resulting in an enhanced electrode potential of the aluminum alloy film, and in reduction of a difference of electrode potential from the transparent conductive film, thus preventing the galvanic corrosion.

As described above, the above-mentioned heat treatment may be applied to the aluminum alloy film so as to further improve the electrical conductivity and corrosion resistance to the transparent conductive film.

### Example 4

### Measurement of Electrical Resistivity of Aluminum Alloy Film

An alkali-free glass plate (of 0.7 mm in thickness and 4 inches in diameter) was prepared as a substrate. Each aluminum alloy film shown in Tables 1 to 6 (each having a thickness of about 300 nm) was deposited on the surface of the substrate in the same way as Example 1. Thereafter, the photolithography by the TMAH and the etching was performed on the sample without performing the heat treatment after the deposition thereby to process the sample into a stripe-like pattern (pattern for measuring an electrical resistivity) having a width of 100 μm and a length of 10 mm. The electrical resistance of the pattern was measured at room temperature by a direct-current four-probe method using a prober. The sample having an electrical resistivity exceeding 50 μΩ·cm was determined to be bad, while the sample having an electrical resistivity of 50 μΩ·cm or less was determined to be good. The same measurement was performed on the sample having a pure aluminum film formed thereat instead of the aluminum alloy film.

The results are also shown in Tables 1 to 6. As can be seen from Tables 1 to 6, the larger the alloy element (X-group element and Z-group element) content of the first aluminum alloy film, or the alloy element (X-group element, Ge, and a rare-earth element) content of the second aluminum alloy film, the larger the electrical resistivity. In order to reduce the electrical resistivity, the total content of the X-group element and Z-group element of the first alloy film, or the total content of the X-group element, Ge, and the rare-earth element of the second alloy film needs to be equal to or less than 10 atomic

### Example 5

### Evaluation of Resistance to Resist Stripper

An alkali-free glass plate (of 0.7 mm in thickness and 4 inches in diameter) was prepared as a substrate. Each aluminum alloy film shown in Tables 1 to 6 (each having a thickness of about 300 nm) was deposited on the surface of the substrate in the same way as Example 1.

The aluminum alloy film was subjected to the heat treatment at 320° C. for 30 minutes in a nitrogen flow, while simulating a thermal history in a manufacturing process, and then immersed in an aqueous solution (adjusted to pH10) of an amine-based resist stripper (“TOK106”(trade name) manufactured by Tokyo Ohka Kogyo Co., Ltd) for 5 minutes. The number of black dots found in the aluminum alloy film after immersion was compared with that of black dots found in the Al-2at. %Ni-0.35at. %La alloy film after immersion. When the former was much smaller than the latter, the former aluminum alloy film was judged as “A(very good)”. Further, when the former was smaller than the latter, the former aluminum alloy film was judged as “B(good)”. Moreover, when the former was equal to the latter, the former aluminum alloy film was judged as “c”. Further, when the former was larger than the latter, the former aluminum alloy film was judged as “D(bad)”.

The same evaluation was performed on the sample with the pure aluminum film formed thereat instead of the aluminum alloy film.

The results are also shown in Tables 1 to 6. As can be seen from Tables 1 to 6, in order to enhance the resistance to the resist stripper, the Z-group element content or Z’-group element content needs to be 0.05 atomic % or more, preferably, 0.15 atomic % or more. Since especially Cu is contained in the aluminum alloy material, precipitates resulting from the X-group element were made finer. As a result, it was considered that the aluminum alloy film was hardly corroded even when being exposed to the removing aqueous solution, and thus exhibited more excellent resistance to the resist stripper.

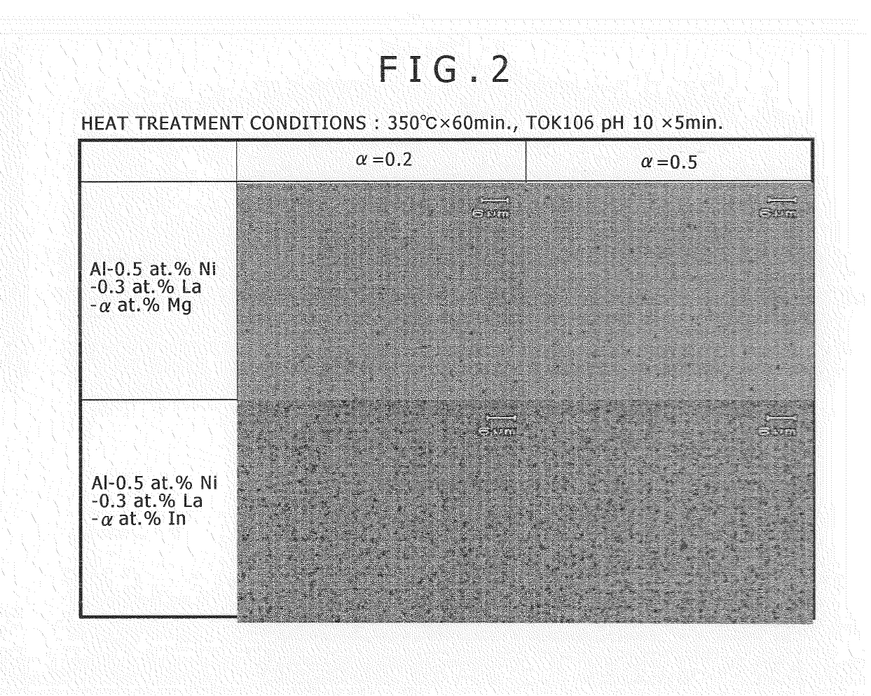

The surface of each aluminum alloy film after the immersion was observed by an optical microscope. FIG. 2 shows examples observed. As can be seen from FIG. 2, the film obtained by adding In (which is not the alloy element defined by the invention) to an Al—Ni—Li alloy had black dots over the entire surface of the film, and thus cannot have the resistance to the resist stripper. In contrast, the aluminum alloy film of the invention obtained by adding Mg to the Al—Ni—La alloy has a few black dots. Such an effect was also able to be seen in the Z-group element or Z′-group element in addition to Mg. This shows that the addition of the Z-group element or Z′-group element in a recommended amount can ensure the resistance to the resist stripper.

### Example 6

### Evaluation of Resistance to Developer

An alkali-free glass plate (of 0.7 mm in thickness and 4 inches in diameter) was prepared as a substrate. Each aluminum alloy film shown in Tables 1 to 6 (each having a thickness of about 300 nm) was deposited on the surface of the substrate in the same way as Example 1.

The resist application, exposure to light, and development using a developer (TMAH) (2.38% by mass) were performed on each aluminum alloy film. Then, the resist was stripped by acetone. A thickness of the aluminum alloy film was measured by a step profiler. Then, an etching rate equivalent (amount of decrease in thickness per minute) of the aluminum alloy film by the TMAH was determined. The amount of decrease in thickness per minute was compared with that of the Al-2.5 at. % Ni alloy film. When the former was smaller than the latter, the former aluminum alloy film was judged as “A(good)”. When the former was equal to the latter, the former aluminum alloy film was judged as “B”. When the former was larger than the latter, the former aluminum alloy film was judged as “C(bad)”.

The same evaluation was performed on the sample having the pure aluminum film formed therein, instead of the aluminum alloy film.

The results are also shown in Tables 1 to 6. From Tables 1 to 6, it can be confirmed that the addition of the Z-group element or Z′-group element reduces the reduction in thickness (etching amount) of the aluminum alloy film in immersion in the developer, thus contributing to improvement of the resistance to the developer of the aluminum alloy. In order to sufficiently exhibit such an effect, the Z-group element content or Z′ group element content needs to be 0.05 atomic % or more.

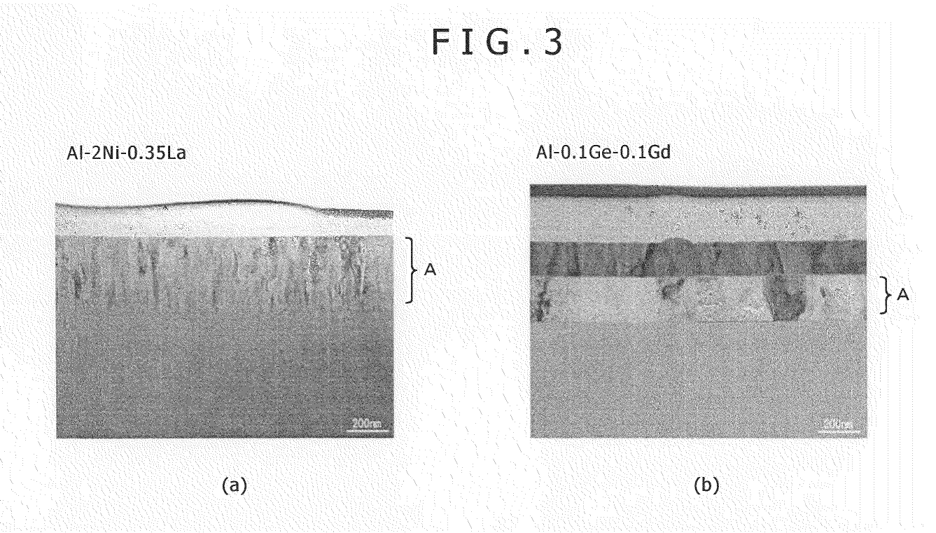

By way of examples of observation of the structures of the aluminum alloy films, FIG. 3(a) shows a TEM photograph of the section of an Al-2 at. % Ni-0.35 at. % La alloy film, and FIG. 3(b) shows a TEM photograph of the section of an Al-0.1 at. % Ge-0.1 at. % Gd alloy film. By comparing the part A of FIG. 3(a) with the part A of FIG. 3(b), the Al-2 at. % Ni-0.35 at. % La alloy film (a) satisfying the composition of the invention has fine crystal particles.

The aluminum alloy film defined as “A” in the total evaluation was one having a film hardness of 2 to 15 GPa, judged as good (contact resistance of 150Ω or less) in the evaluation of the electrical conductivity, and having an electrical resistivity of 50 μΩ·cm or less, an evaluation level of the resist stripper resistance of “A” to “C”, and an evaluation level of the developer resistance of “A” or “B”. The aluminum alloy film other than the above-mentioned one was defined as B in the total evaluation.

The invention has been explained in detail or with reference to the specific embodiments. However, it will be understood to those skilled in the art that various changes and modifications can be made without departing from the spirit and scope of the invention.

The Present application claims priority from Japanese Patent Application No. 2008-041662 filed on Feb. 22, 2008, the content of which is hereby incorporated by reference into this application.

### INDUSTRIAL APPLICABILITY

According to the present invention, the touch panel sensor includes the guiding wiring made of the prescribed aluminum alloy film, which can reduce the electrical resistance of the wiring, while directly contacting the transparent conductive film to the wiring. Further, the touch panel sensor hardly causes poor connection of the wiring in coupling to the external device (controller), and also hardly causes disconnection or an increase in electrical resistance with the elapse of time. Therefore, the invention can provide the touch panel sensor with high reliability. The guiding wiring can be subjected to fine processes by forming the prescribed aluminum alloy film by sputtering, and applying photolithography and etching processes. Further, the resistance to the developer and the resist resist stripper used in the manufacturing process of the touch panel sensor can be improved. Further, since an intervening layer for ensuring the electrical conductivity is not required to be provided between the transparent conductive layer and the aluminum alloy film, the touch panel sensor can be manufactured by the simple process without increasing steps of the process.

1. A touch panel sensor comprising:
a transparent conductive film; and
a guiding wiring directly contacted to the transparent conductive film, said guide wire comprising an aluminum alloy film,
wherein the aluminum alloy film comprises 0.2 to 10 atomic % in total of at least one element selected from the group X consisting of Ni and Co, and
wherein the aluminum alloy film has a hardness of 2 to 15 GPa.

2. The touch panel sensor according to claim 1, wherein the aluminum alloy film further comprises 0.05 atomic % or more in total of at least one element selected from the group Z consisting of a rare-earth element, Ta, Ti, Cr, Mo, W, Cu, Zn, Ge, Si, and Mg, and
wherein the total content of the at least one element selected from the group X and the at least one element selected from the group Z is equal to or less than 10 atomic %.

3. The touch panel sensor according to claim 1, wherein the aluminum alloy film further comprises 0.15 atomic % or more in total of at least one element selected from the group Z consisting of a rare-earth element, Ta, Ti, Cr, Mo, W, Cu, Zn, Ge, Si, and Mg, and
wherein the total content of the at least one element selected from the group X and the at least one element selected from the group Z is equal to or less than 10 atomic %.

4. The touch panel sensor according to claim 2, wherein the aluminum alloy film further comprises the rare-earth element as the at least one element selected from the group Z, the rare-earth element content being 0.05 atomic % or more, and
wherein the total content of the at least one element selected from the group X and the rare-earth element is equal to or less than 10 atomic %.

5. The touch panel sensor according to claim 2, wherein the rare-earth element is one or more of elements selected from the group consisting of Nd, Gd, La, Y, Ce, Pr, and Dy.

6. The touch panel sensor according to claim 2, wherein the aluminum alloy film comprises Cu as the at least one element selected from the group Z, the Cu content being 0.05 atomic % or more.

7. A touch panel sensor comprising:
a transparent conductive film; and
a guiding wiring directly contacted to the transparent conductive film said guide wire comprising an aluminum alloy film,
wherein the aluminum alloy film comprises 0.02 atomic % or more in total of at least one element selected from the group X consisting of Ni and Co, and 0.2 atomic % or more of Ge,
wherein the total content of the at least one element selected from the group X and Ge is equal to or less than 10 atomic %, and
wherein the aluminum alloy film has a hardness of 2 to 15 GPa.

8. The touch panel sensor according to claim 7, wherein the aluminum alloy film further comprises 0.05 atomic % or more in total of at least one element selected from the group Z′ consisting of a rare-earth element, Ta, Ti, Cr, Mo, W, Cu, Zn, Si, and Mg, and
wherein the total content of the at least one element selected from the group X, Ge, and the at least one element selected from the group Z′ is equal to or less than 10 atomic %.

9. The touch panel sensor according to claim 8, wherein the aluminum alloy film further comprises the rare-earth element as the at least one element selected from the group Z′, the rare-earth element content being 0.05 atomic % or more, and
wherein the total content of the at least one element selected from the group X, Ge, and the rare-earth element is equal to or less than 10 atomic %.

10. The touch panel sensor according to claim 8, wherein the rare-earth element is one or more of elements selected from the group consisting of Nd, Gd, La, Y, Ce, Pr, and Dy.

11. The touch panel sensor according to claim 8, wherein the aluminum alloy film comprises Cu as the at least one element selected from the group Z′, the Cu content being 0.05 atomic % or more.

12. The touch panel sensor according to claim 1, wherein the aluminum alloy film has an electrical resistivity of 50 μΩ·cm or less.

13. The touch panel sensor according to claim 1, wherein the aluminum alloy film has an electrical resistivity of 25 μΩ·cm or less.

14. The touch panel sensor according to claim 1, wherein the transparent conductive film is substantially made of indium tin oxide (ITO) or indium zinc oxide (IZO).
